(19) United States
(12) Patent Application Publication
(10) Pub. No.: US 2004/0237178 A1
(43) Pub. Date: Dec. 2, 2004

(54) Self-contained on land on water in air protective apparatus for mass protection and mass continuation

(76) Inventor: Gaspar Landeros, Odessa, TX (US)

Correspondence Address: GASPAR LANDEROS, 1500 N. MUSKINGUM AVE., ODESSA, TX, 79761, US

(21) Appl. No.: 10/854,694

(22) Filed: May 25, 2004

Related U.S. Application Data
(60) Provisional application No. 60/473,781, filed on May 27, 2003.

(51) Int. Cl. A62B 17/00; A41D 13/00

(52) U.S. Cl. 2/457

(57) ABSTRACT

My inventions aspire to improve the protection for human beings, against extreme conditions, where conventional safety and protective equipment are not practical for use in mass protection and mass continuation of human beings. My invention is designed to improve the chances of survival, because of the ability to collect, and recirculate the air through air-filters, for human consumption and for heating and cooling of the body. All of these is done by the air supplied by the air-compressors integrated to the protective suit, and with a minimal of stress to the lungs, because the person does not have to suck air through APR respirators once the air-tanks are filled with air. Also, improve the chances of survival in extreme conditions because of the diversity of tools and the toughness of the materials used. All done without the aid of electric motors or fans.

### BACKGROUND OF THE INVENTION

The main purpose of my invention is to help make this world of ours a better place to live on! To serve and unite mankind by the idea of protection, for human prosperity! By doing this, I think future generations will appreciate any thing and every thing that will help to neutralize the horrendous acts of violence committed on this earth.

Us, humans, continuing with our lives, means' keeping our nations alive!

The idea came after constantly hearing on the news of weapons of mass destruction, and the U.S. department of homeland security instructing the public on how to seek shelter in a room with supplies for protection in case of terrorist attacks.

Also, In the EXECUTIVE SUMMARY of the DOT/FAA-97/99 Office of aviation, research report, states that: “Forty percent of the passengers who survive the impact of an aircraft accident subsequently die in a postcrash fire.” The report continues to explain that the FAA is looking for technology that will reduce the combustible material inside of the fuselage.

I, believe, that the public having better protection for emergencies, can support our selves and the emergency personnel a lot better in case of any kind of disaster! The person wearing my invention has a better chance of surviving an aircraft crash and post crash fire.

The sweat, the high humidity caused by the exhalation of the lungs, the itchy sensation produced by the poor blood circulation between the rubber mask and the skin and of course the over heating of the face in high temperatures. All of these symptoms are caused by the Self Contained Breathing Apparatus SCBA and Air Purifying Respirators APR. Which the person, cannot alleviate the desperation of wearing this kind of apparatus, until they're out of the danger zone! My invention eliminates most of the worst symptoms of wearing a SCBA, APR, and a conventional rubber protective suit.

Well, my invention is designed to “maximize” the changes of protecting the individual that is wearing it. If he or she might find them self's in a place, not so comfortable for the human body.

If in doubt, of area contamination, it will aid the personnel that have to bring back order for the public, like the soldiers, emergency personnel or the electricians that have to restore power. The intention is to offer some support to the person wearing it to continue with it's daily life.

My invention provides filtered air, and heated or cooled air if necessary without the lungs having to suck air through filters.

I have worked outdoors in cold temperatures, my toes, fingers, and face are cold but my rest of the body gets hot after a few minutes of hard work. My invention can heat-up, the toes, fingers, and face but at the same time cool down the rest of the body.

I think that nobody should work without the right tools, and this includes breathing quality air, and heating and cooling of the body at the job site!I want to add to the history of the invention that part of the idea, came to me, because I suffer from back-pain. Because of this suffering, I was experimenting with the possibility of making an air-adjustable back support. Because I'm allergic to some pain killers, I had to find a way to help alleviate the pain, and reduce the use of pills. By putting all of these ideas together, I came up with the essence of the invention. Then, the final product came, by applying the knowledge I have of life.

### SUMMARY OF THE INVENTION

I Gaspar Landeros, came up with the idea of protecting the human body from the elements and adverse conditions. In a way of having air and/or liquids circulate throughout the protective suit, while semi-isolated and isolated from the environment and for the purpose of helping the lungs to breathe a bit easier and for the body to stay a little cooler or warmer, while the person is inside a protective suit.

The key for achieving this is to use human momentum while the person is carrying-on with it's daily activities, with minimal of distraction and agitation.

Humans and some animals, for thousands of years have been wasting precious energy that can be generated every time we take a step or hop from one place to another.

If we install, wear and/or connect under our feet any kind of power generating devices that we can transport as part of our outfit, the uses can be unlimited.

Wherever the person or animal goes on, this earth can use my invention, and is called, the Self-contained on land on water in air protective apparatus for mass protection and mass continuation. Which I will refer to as suit, protective suit, survival suit, coveralls or it in the following disclosures.

This survival suit 10, might not protect the individual that is wearing it, if struck or stopped by any kind of force, temperature, friction, or substance greater than what the suit is designed to withstand.

This survival suit 10 contains the in-line pressurized air-filtration system 25, which helps the person that is wearing it to breathe easier, among other things. Comparing the suit 10 versus the conventional suits that have APR respirators, which the human lungs are the ones that have to continually suck the air through the respirator-filters! Thus fatiguing, a lot quicker, any person using a regular APR respirator!

If the person that is wearing the suit 10 is cornered by fire, the person can totally isolate, from the ambient by closing the filter covers 13 and walking through the fire to safety. With practice and agility using the survival suit, the chances may be greater of surviving the moment of distress.

The protective suit 10 also includes features other than assisting in breathing, cooling or heating, therefore making it more practical for everyday use. These other features are explained in the description of the invention, and of course the protective suit is not limited for emergency use only, but for other occasions too.

To name a few examples, the person, that's mowing the lawn, can use it to keep air-born particles off the skin, lungs and clothes. Some of these particles can be herbicides, pesticides, the smog from the gasoline emissions from the mower and/or of the gas trimmer.

The protective suit 10, can assist asthma sufferers by breathing filtered-air any where they go, but without the hassle of their lungs sucking for air through filters that may fatigue more rapidly the lung muscles.

The outdoors person can use the protective suit to eliminate the use of a tent and sleeping bag if away from camp.

The news reporter and camera person can use it when reporting from a riot, can be a little more protected, from flying objects.

It can be used for exercising or just for fun activities.

The protective suit 10 can be manufactured of many different materials and styles, all depending in the individuals necessities.

My invention consists of compressors and electric generators operated by the feet, legs and weight of the body. This includes the tools and accessories that help the suit work.

For disabled persons, the design is a little different because the protective suit 10 is operated by the hands or feet, depending on the situation of disability of each person.

### DESCRIPTION OF DRAWINGS

FIG. 1 is a front elevational view of the protective coverall or suit with integrated helmet, gloves, and boots.

FIG. 2 is the left side elevational view of the protective suit showing the extended position of the helmet and the suit.

FIG. 3 is the right side elevational view of the protective suit's expendable helmet with goggles.

FIG. 4 is the right side elevational view of the protective suit's expendable helmet with face shield.

FIG. 5 is the right side elevational view of the protective suit's expendable helmet with face shield in the extended or expended position.

FIG. 6 is a side elevational open view of the left side of the protective suit's boot showing a partial view of a foot, shoe, air-hoses, valve housing and air-compressor.

FIG. 7 is the back elevational open view of the boot showing a partial view of the back of a foot, shoe, air-hoses, valve housing and air-compressor of the protective suit.

FIG. 8 is a top plane view of the left shoe inner sole showing the location of the holes for the toes and foot ventilation, heating and cooling system, plus the location of the intake and pressure side of the check valves for the air-compressor.

FIG. 9 is a back elevational view of the emergency APR respirator connected to the in-line pressurized air-filter system of the protective suit.

FIG. 10 is a right side elevational view of the emergency APR respirator showing the connection tubes to the in-line pressurized air-filter, the APR filter and the exhale valve tube.

FIG. 11 is an elevational view of the in-line pressurized air-filter.

FIG. 12 is an elevational view of the air pressure regulating and air distribution block.

FIG. 13 is an elevational view of a flexible air-tank.

FIG. 14 is a side view of the right hand glove of the protective suit showing the gloves' fingernails, the heating-cooling-ventilation air-hose, the relax form of the hand and the hand relaxation pouch.

FIG. 15 is a front elevational view of the heating system inside of a pouch for the protective suit.

FIG. 16 is an elevational view of the heating system gyroscope style rings and frame for the purpose of maintaining the candle, or 3.3% methyl alcohol cooking gel can, level at all times, regardless of body position.

FIG. 17 is the left side partial elevational view of the protective suit showing the “chair legs and plastic bag for the toilet system” of the protective suit.

FIG. 18 is an elevational view of a person wearing the perforated parachute frame for forced jumps from burning buildings.

FIG. 19 is an elevational view of a person wearing the perforated frame for the self ejection of the parachute for forced jumps from burning buildings, showing the parachute in the extended position with the inflatable outline skirt inflated with helium gas.

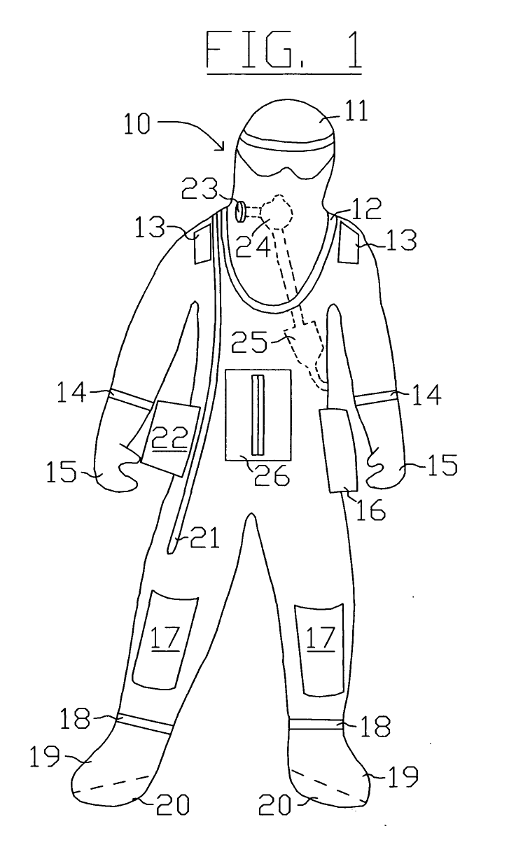

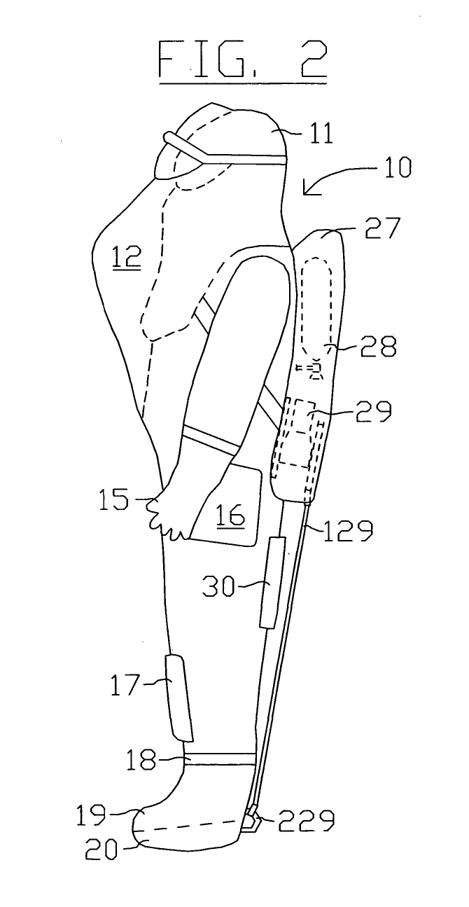

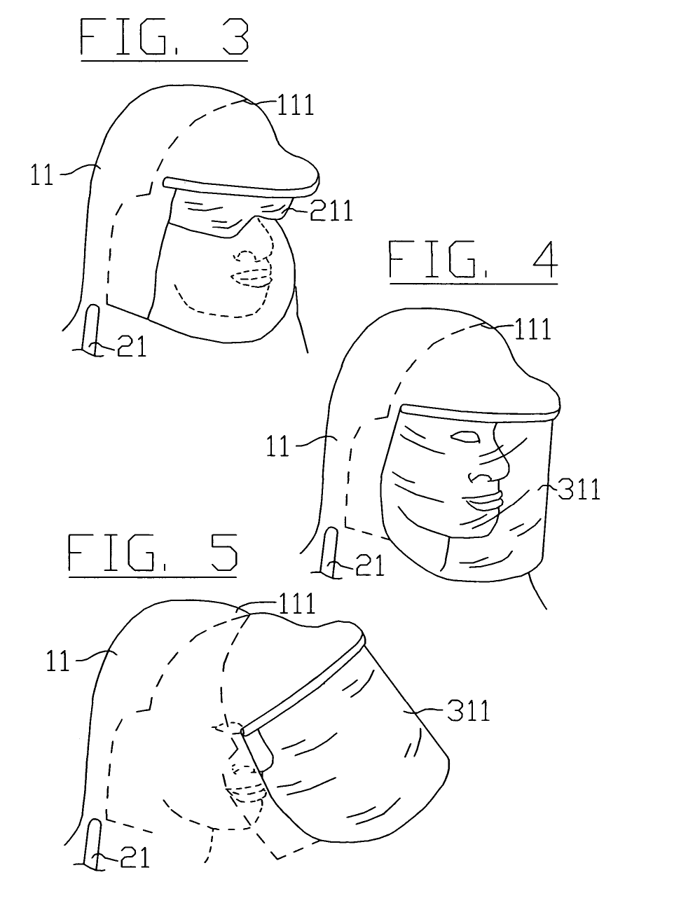

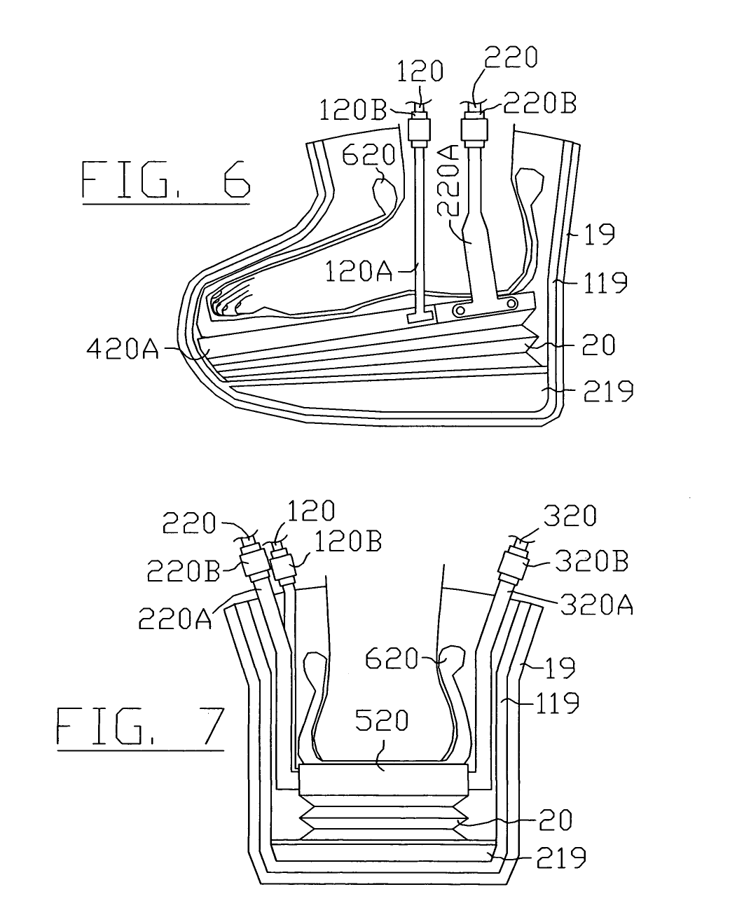

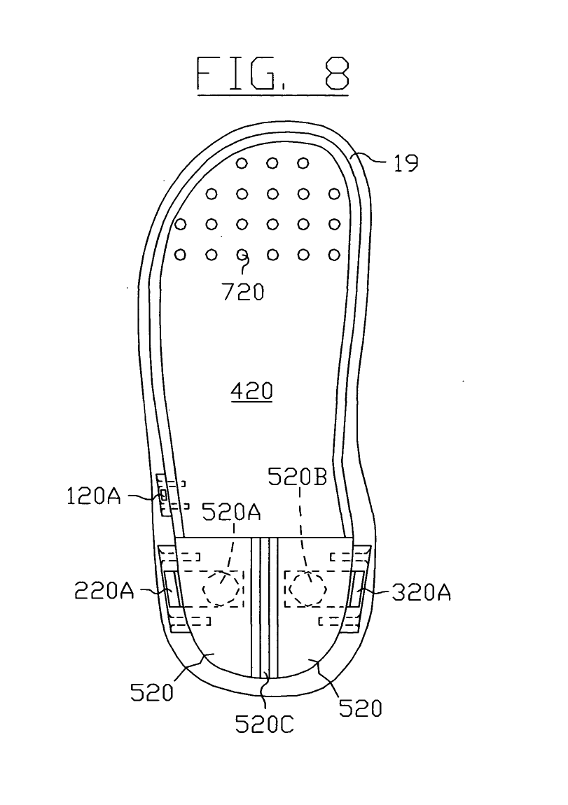

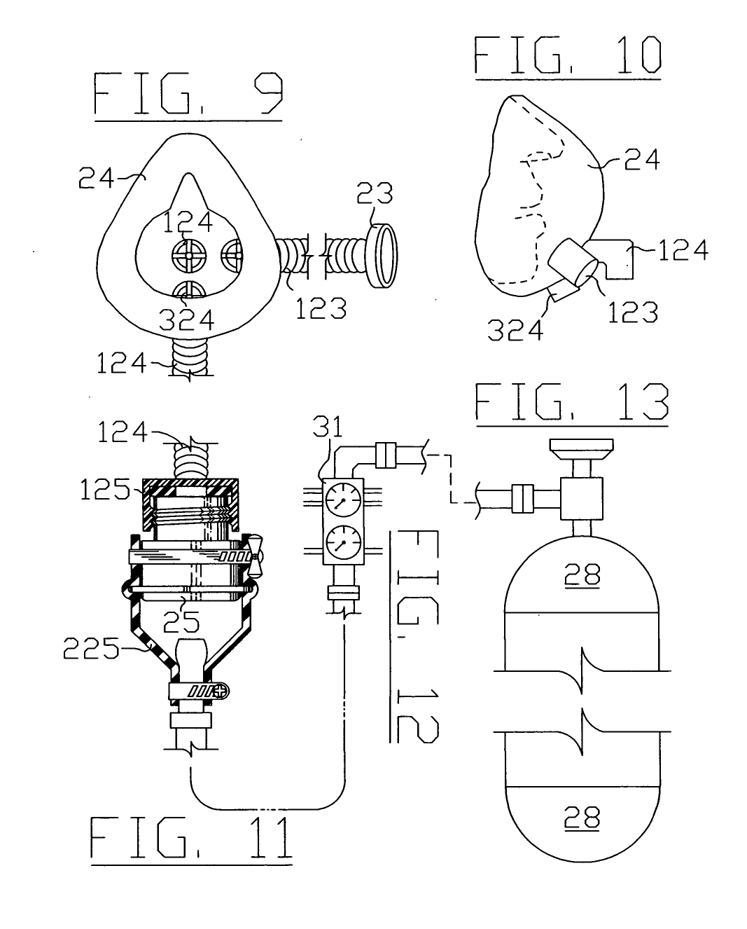

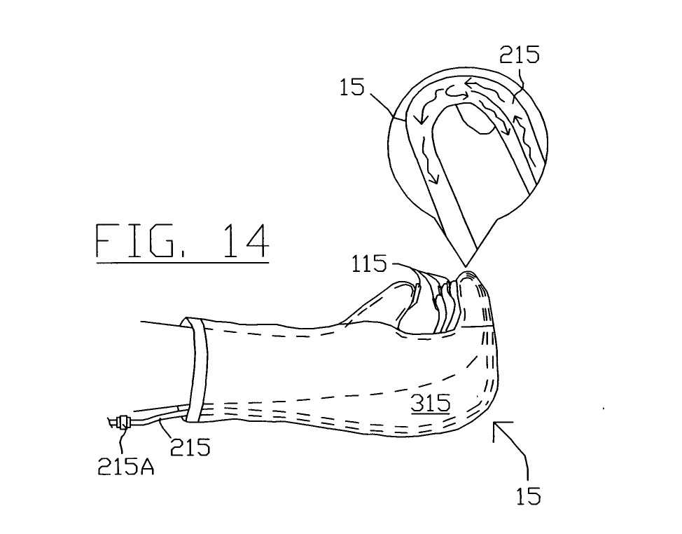

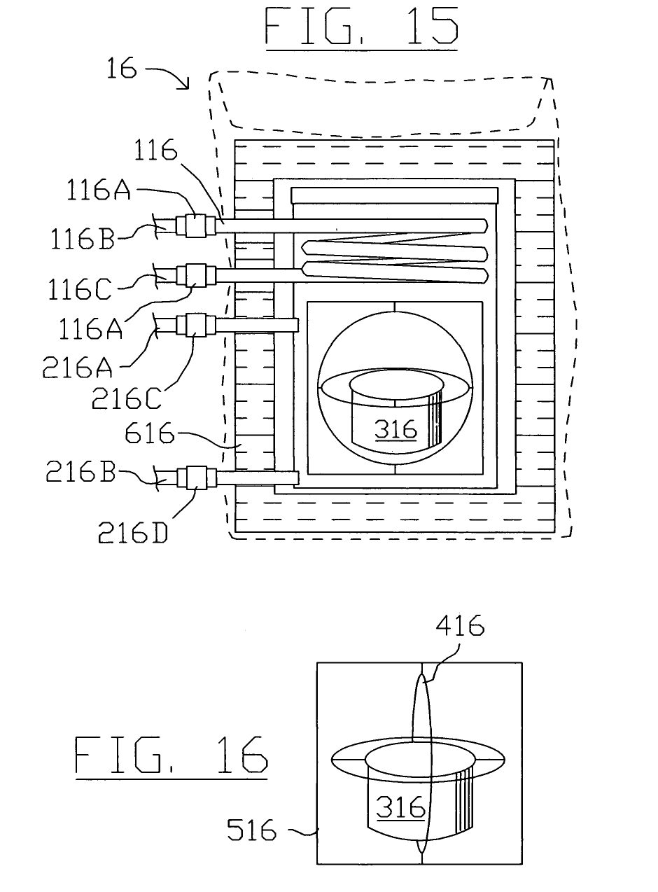

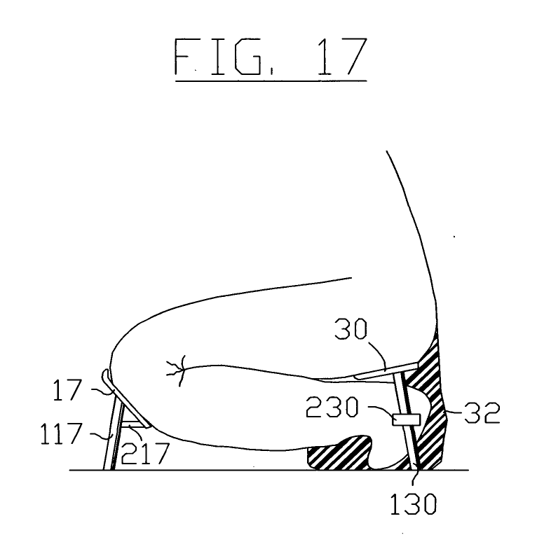

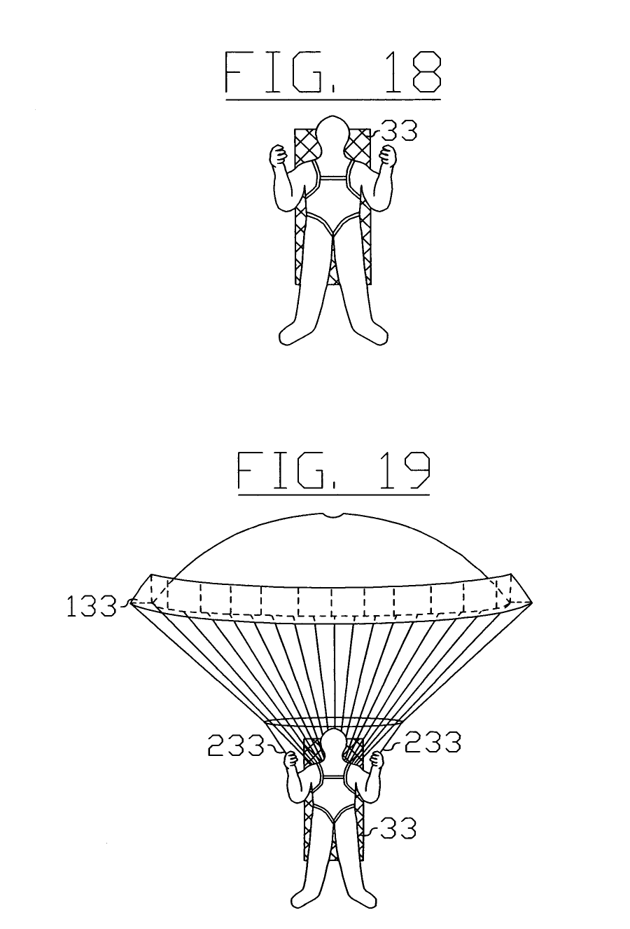

### DESCRIPTION OF THE INVENTION

Once the person is inside the protective suit 10, and seals the air-water tight zippers 21, the person is semi-isolated from the ambience. He or she can use the already stored and filtered-air inside of the flexible air-tanks 28. Then by walking, the person activates the compressors 20 that are attached to the bottom of the shoes, and inside the protective boots 19, which are part of the suit 10.

From the surrounding area, the air-supply is collected and filtered through strategically located air-filters 13 at shoulder level and inside the suit there is an in-line air-filter 25 connected to a plastic tube 124 that comes from the flexible air-tanks 28 and takes the air to the front of the face for air consumption.

The air-collection is done by suction created inside of the “shoe air-compressors” 20, by the wearer taking a step, thus releasing the pressure from body weight. Then the air is compressed out of the shoe air-compressors 20, by pressure exerted by the body weight of the wearer, therefore sending the air to a flexible air-tank or tanks 28.

From the air-tank 28, pressure is regulated 31 for use and distribution to the many functions of the suit 10.

The first function of filtration 13, is removing as much particles from the air as possible, without restriction of air-volume.

Second, the collected air is forced by the tank 28 air-pressure through another finer filter 25 and then for air consumption.

The location and mechanism of the “shoe air-compressors” 20 are as follows: The “bellow” 20 or “accordion” 20 type air-compressors are directly under the shoes.

In the shoe heels 520 of the shoes 620, there are intake-check-valves 520A and a pressure-check-valve 520B for the function of the “bellow” or “accordion” air compressors under the shoes.

The piston type air-compressor 29 is located in the backpack 27 and connected by a rope or strap 129 to a loop 229 located in the back bottom of the protective boots 19. When either leg is bend, the rope winds into a set of spring-coiled pulleys, connected to the piston-shaft of the compressor 29, then when the leg is extended, the roller bearing-clutch engages the coil frame to the piston-shaft assembly for rotation.

The suction side of the piston-compressor, is connected to the primary air-tank and also to the primary air-filters 13. The discharge side of the compressor is connected to the secondary air-tank. The secondary air-tank holds higher air-pressure, for the movement of air through the finer air-filters 25, and reverse osmosis water-filters, etc.

Another auxiliary air-compressor for the use with the suit 10 is a removable bellow type air-compressor that attaches to the inner thighs of the legs. This compressor works by attaching one end of the bellow to one leg and the other end to the other leg at knee level. Then by opening the legs, air is sucked through the intake-valve and then by closing the legs, air is compressed out of the bellow through the discharge-valve to one of the flexible air-tanks 28.

An example for the use of this compressor is, when the person is resting and needs air circulating through the suit 10, can do so by opening the legs and then the weight of one leg against the other pushes the air out of the bellow.

The coverall 10 is made of different layers of materials. The outermost layer can be made of any kind of fire-resistant fibers like high texturized glass yarn or polyamides base fibers like Aramid, Nomex, Karmel HTA combined with Paramide, these are some of the materials that can be used for the fire-resistant protective suit 10.

The outer layer of the suit 10 also includes fire-resistance straps with fasteners just incase of fire, the person has to suspend itself, like from a ledge of a window and at the same time have the hands and arms free.

The next layer can be made of high-temperature resisting plastic followed by a layer of HT glass yarn or other insulating material.

After the insulation, there is a rubber suit which has the integrated inflatable shirt and pants. For the inner shell there is a removable and washable coverall made out of cotton, linen, or synthetic fibers designed to keep the body cool like some fibers from the nylon family.

In addition the coverall has an expandable helmet 11 and the front of the suit extends 12, for relaxation of the head and arms.

Also has other purposes, for example, if it's raining or in a sand storm and the person wearing the protective suit 10 needs to read a map for directions, can do so by stretching the front of the suit 12 and expanding the helmet 111. Then the person pulls the arms out from the sleeves of the suit and reach inside to the inner-pocket to grab the map or Global Positioning System. Also the expansion is helpful when eating, sleeping and using the Human waste evacuation system FIG. 17.

There are two styles of helmets 11 and two styles of inflatable hoods, one is with goggles 211 and the other style is with a face-shield 311 both with high-impact resistant thermoset polycarbonates or mold injection thermoplastics. The lenses for the goggles and face-shield are double with a ½” gap between the lenses with total vacuum for insulation purposes, and added protection.

The air-hoses for the air circulation are attached to the air-supply and air-pressure regulator block 31 and are integrated to the rubber suit. The air-hoses are routed through the anterior and sides of the rubber suit for better air circulation. The air-intake hose 220 with a quick connect 220B are semi-rigid to prevent collapsing with the vacuum caused by the suction of the air compressors 20, yet flexible enough for body movement.

The pressure side air-hose 320 with quick connect 320B are made of vinyl and/or polyethylene, except the tubing coming out of the piston type compressor 29 which are made of aluminum.

The low-pressure air hoses through out the suit are made of soft rubber latex for body movement and flexibility. These soft rubber hoses take the air from the air-tanks through the heating 16 or cooling box 22, then to the perforations inside of the helmet or hood. There are also rubber hoses going to the neck, back, armpits, chest, area of the suit, and inside of the pants' legs, also to the gloves 215, sleeves and inner shoe-soles 720.

All of these hoses are for the ventilation, heating and cooling of the entire body. Some Methyl-based gel alcohol (cooking fuel in a 4 oz can) or paraffin-based fuels are needed for heating, and the use of dry-ice or regular-ice are needed for cooling the protective suit 10.

### Gloves

The gloves with tools 15 have several features. One of these features is the ventilation of the gloves, and is done by the circulation of air from the air-tanks through a set of flexible air-hoses 215 with quick connect 215A. If, the air first passes through the heater-box 16 or the cooler-box 22 the air will ventilate, and heat or cool the hands and body.

The glove-fingernails 115, these are interchangeable fingernails and are on the palm side of the gloves. The thumb and fingers have aligning nails for the purpose of grasping small objects, therefore eliminating the desperation of wearing gloves when handling small objects! For example, emergency personnel can handle small needles and tubes and at the same time keeping their hands dry from the sweat created from the conventional latex gloves.

The index finger does not have a fingernail for the purpose of handling power tools and firearms.

The gloves have the relaxed form of the hand and comes with a chamber 315. These glove chambers 315 are for the relaxation of the hands and fingers, outside the gloves' fingers, which may help in the prevention of frostbite.

Other tools (optional) included in my design are, a measuring-tape which is integrated to the right-hand glove, at about wrist level and the end of tape comes out at the base of the thumb and palm of the glove. The measuring-tape runs between the first two layers of materials of the glove. Pencils are integrated to the tip of each forefinger. At the wrist an air-hose extends and folds for use with tools or just as an air-blower. Other tools can be added depending on the job requirements.

### Human Waste Evacuation System and Water Filtration System

The human waste evacuation system and the water in the urine recovery system are essential for the survival of the wearer if the surroundings are limited of potable water or don't permit the use of a restroom. Example, if the temperature is too cold, the person wearing the protective suit 10 doesn't need to exit the suit if the necessity of going to the restroom arises. The toilet system may save the person from getting a possible illness, from the abrupt temperature change of getting out of the protective suit.

The human waste evacuation system is composed of the following:

(1). The urine collection system works in the following manner.

(a). In the male, the penis is covered with a latex or vinyl like “condom” funnel surrounded by a plastic diaper filled with poly (acrylic acid) for any accidental spills. Then this funnel is connected through a plastic tube to the urine disposable plastic bag or urine collection bag. Example, if out in the wilderness, the water in the urine can be recycle using the water filtration system.

The water filtration system is a syringe like, piston-cylinder which holds and pushes the urine by air-pressure thru the filters. The air, pushing the piston of the syringe never comes in contact with the urine.

Is very important that the urine be process as soon as possible into filtered water before the urine decomposes. The urine filtration is best if done within 15 min. of urine collection.

The water filters are chemical removing filters followed by bad taste removing filters and finally by a reverse osmosis filter. The filtered water is deposited in a plastic bottle for human consumption. This process is possible by the air compressors 20, 29 integrated to the protective suit 10.

(b). In the female, The urethra is covered by a ½″×1″ plastic oval cup-funnel and the rim of the cup is covered with a plastic diaper filled with poly (acrylic acid) for absorption of any spilled urine. The cup-funnel is then connected to the rest of the system, (whish is the same as for the male system). For the vagina is a 3″ long×½″ tube covered by a soft silicone gel that forms to the shape of the opening of the vagina and finally a disposable feminine napkin to absorb any leakage. This tube is used to drain the menstrual discharge or to apply and drain vaginal douches. Finally discharged to a disposable plastic bag with absorbing material. The system can be secured by hand or by a strap that starts at a waistband than goes over the cup and tube, then between the legs and back up to the waistband.

2. “The solid waste discharge system” works in the following manner, the suit is equipped with two sets of aluminum, steel or carbon-fiber (folding or retracting) legs. One set of these legs is attached to the back of the suit's upper leg section 30 and the other set of legs 117 are attached to the knees 17. The set of legs attached to the knees, serve as shin-guards and knee protectors 17. Which extend and locks with a brace 217, so that the person kneels against these legs 117 and at the same time sits over the other set of retracting legs 130. The set of retracting legs fastens to the side of the protective boots 19 for more support. These legs are secured by straps 230 connected to the protective boot. When the wearer sits down with the crouch-buttock sipper open the suit tends to spread apart by the weight of the person.

The suit 10 at the crouch-buttocks has a double compartment that opens and closes with zippers which make it possible to open one compartment at a time. By opening the exterior compartment a vinyl plastic bag 32 hangs out off the suit. From the inside, the wearer pulls the arms out off the suit's sleeves and to access the inner plastic zipper. Once this zipper is open, the wearer hangs a disposable unzipped plastic bag to the sides of the opening of the hanging vinyl bag 32.

The person proceeds to put on a set of vinyl or latex gloves for personal hygiene, and proceeds with its necessities. After the person finishes doing his or her necessities, then closes the soiled disposable plastic bag and drops it to the outer hanging plastic compartment 32. Then by closing the inner plastic zipper, the person is still isolated from the cold or possible contaminated area. The wearer then pulls off the vinyl or latex gloves before putting the arms back into the sleeves and gloves 15. Once the wearer has the hands and arms back in the suits sleeves can proceed to unzip the exterior front of the plastic bag between the legs. Now the soiled disposable plastic bag can be removed and discarded off. The hanging plastic bag 32 is sprayed inside and out with a disinfectant before folding and zipping it back inside the suit 10.

### Disinfection Pocket or Chamber

This disinfecting pocket 26 has a zipper on the outer side of the suit and a zipper on the inner side of the suit. The purpose for this is so that the wearer will be isolated from a possible contamination of the area, can receive sealed plastic bags of food and supplies needed inside the suit. The way this system works is by closing the inner zipper, the object is placed and sprayed in the compartment, then the outer zipper is closed for disinfecting or neutralizing the plastic rapper of the object in the chamber. The wearer proceeds to open the inside zipper of the decontaminating chamber, for removal of the object.

### Deodorant System

The deodorant system is composed of inner pockets for the deodorant and atomizer pump for the body talc and foot powder. The invention requires keeping the body deodorized under extreme conditions, and this is to promote the best hygiene possible without taking a bath.

The deodorant system consists of several inner pockets, an atomizer pump with extension tube to reach the feet for the application of foot powder.

### Reminder Checklist

The reminder checklist is to organize the system.

A general check list is as follows: (1). Have reserved air in all of the flexible air-tanks 28. (2). At least one spare primary air-filter 13 and one in-line air-filter 25. (3). Practice putting on the protective suit 10. (4). Memorize, where the fire-extinguishers are in you building and also know several possible scape routes.

Learn how to use the type of fire extinguishers in you building. When using any type of fire-extinguisher always aim at the bottom of the flames with quick wide swiping motion and if possible shut down the combustible source. (5). For possible terrorist attacks or long periods of time in the protective suit 10 always keep a supply of water in the storage pockets, at least ½ gal. in 8 oz. plastic bottles, throughout the suit for weight distribution. (6). A small flashlight, a small battery operated radio and spare batteries. (7). Some nonperishable food in its original factory plastic bags. (8). Mouthwash. (9). Tablets of bismuth. (10). Aspirin or other over the counter pain killers. (11). Prescribe medication and reading glasses. (12). A few pairs of latex or vinyl gloves. (13). Small boxes of paper tissue. (14). Small boxes of moisten baby wipes. (15). Deodorant, talc and foot powder. (16). Eye drops. (17). Skin moisturizing lotion. (18). Plastic bags for use in the human waste evacuation system. (19). For the ladies, feminine napkins or tampons, vaginal douches and vaginal creams. (20). Small first-aid kit. (21). Butane candle-lighter and a 4 oz. can of restaurant type food warmer gel and/or candles for the heating system 16. (22). A plastic bag that hangs inside the suit, but in front of the person just in case the person needs to vomit. (23). Know were to get dry-ice or have regular ice ready in the freezer for the cooling system 22. A power plant comes handy in case of a power outage.

### Flotation, Impact, Air-Mattress, Body Support System

The system is divided into several compartments just in case one is punctured, the rest of the compartments will remain inflated. Also the top of the suit inflates separately from the bottom part, to achieve “upright” flotation position. Each air-bag has a plastic one way air-valve for each set of air-bags, and pressure-relief valves. Another set of adjustable air-bags around the waistline and lumbar area are included in the suit for body, and back support and back comfort.

This system includes (optional) four telescoping poles that can be used to lift the wearer or to lower the wearer from the roof of a one story high building or used as stilts.

The telescoping poles are made of carbon fibers for lightness, flexibility and toughness. These poles are pneumatic pistons-cylinders and extend to 64″ and can lift 300 plus pounds in a balanced manner. When the poles are air-pressurized with the suite's 10 integrated compressors, or nitrogen, they extend thus lifting the person off from the ground.

These poles are attached to the outside of the backpack and have folding arms for control of the poles. These poles are attached in a way that one of the two poles on each side are hinged to the outside of the backpack so that the other pole connected by two crossbars can swing over to the front of the wearer. The back pack attaches to integrated straps that go around the upper side of the legs. These straps go around the legs, through the front of the suit, over the shoulders and down the back of the suit, then back down to the straps around the legs. These straps are adjustable in the front side of the suit 10.

### Air-Bag Rescue Suit with Parachute

The air-bag rescue suit with parachute allows the person to jump off, from a burning building, if trapped in the upper floors and in imminent fire threat.

I have design two types of systems to inflate the air-bags in this kind of suit.

(a). The person gets inside the rescue suit, then proceeds to close the suit entrance with the velcro straps.

Once the suit is closed, the person goes out to a balcony or out the exit to the roof of the building or through a window and suspends from the window frame with a fire resistant hook and strap integrated to the rescue suit. When the person is out of the building can now start to inflate the air bags with either nitrogen, helium, Co2 gases or for a last resort with the air from the protective suit 10 compressors 20, 29. Now the person is ready to jump, and that's only if there is no other way of rescue.

(b). The other design is more complex but with manual and automatic inflation of the air-bags. With this design the person already with the rescue suit on, (1). can step out to a balcony or roof or suspend from a window frame and manually pull the air-bag inflating valve/trigger connected to a nitrogen tank. After the air-bags are completely full the person is ready to jump. (2). For situations were the person has to walk or run through the fire in total darkness and happens to run out through a broken window, the automatic inflating system sends a signal to the relay that activates the solenoid that pulls the inflating trigger of the system.

A more detailed explanation of the automatic inflating system is given in the material's section of the detailed description of the invention.

The parachute is designed to open manually or by the resistance of the wind when the person is accelerating by the free fall. The parachute is design to open in heights less then what it takes a conventional parachute to open.

Before the person takes an emergency jump, I recommend, if possible, to inflate the shirt and pants air-bags and the flexible air-tanks for added protection. If possible, the person planing on using, the parachute should take practice jumps into an air-bag supervised by professionals in this field.

An example of the use of the parachute is if, the wearer is trapped by any imminent life threatening circumstances in the upper floors of a building, and is forced to jump, the system will open in a fraction of the time that it will take a conventional parachute to open. The parachute can be used for jumps from buildings of any height.

Materials used for the fabrication of the parts of the protective suit 10 and air-bag rescue suit with parachute are as follows.

### (1) Air Compressors Integrated to the Protective Suit

The air-compressors are built and attached to the protective suit 10 as follows:

1-A The under the shoe air-compressors 20:

(a). The “under the shoe air-compressor 20,” elastic “bellows” type, is made of 0.05″ of a combination of moldable neoprene and natural rubber latex. This rubber compound is molded to the compressed size of the bellows and in the shape of the shoe sole 420.

The bottom side of the mold has four extensions; ¼″ round×¼″ tall and 1″ apart and across from each other and these extensions are located 1″ from the back side of the bellow mold. These mold extensions are for the formation of the gasket holes. The gasket holes are for the attachment of the below frame to the bottom of the protective boot 19.

The top and bottom gaskets and all the sides around the bellow are of one piece of molded rubber.

The upper part of the mold has five extensions; four of these extensions are ¼″ round×¼″ tall and 2½″ across from one another and these extensions are centered right under the shoe heel. These four mold extensions are for the formation of the gasket holes. Which is design for the attachment of the valve housing 520 to the top of the bellow frame.

The fifth extension is an oval shape and is ¼″ tall×¾″ wide×1½″ long and is located (crosswise to the shoe 620) in the center of the other four extensions. The oval extension of the mold is for the formation of a gasket hole. This gasket hole is for the air passage from the air-intake check-valve into the bellow, and from the bellow through the air-pressure side check-valve and finally to the air-tanks.

Also the under the shoe air-compressor 20 can be manufactured in the shape of an accordion and made of other elastomers.

The molded rubber bellow is stretched at the oval gasket hole in order to be assembled over the flexible bellow frame. This elastic “bellow” stretches vertically to 1½″ at the posterior part of the bellow.

(b). The bellow frame, is made of one flexible piece of carbon fiber composites in the shape of a double shoe sole, with a molded angle, making an acute angle of 10 Deg. The measurements at the front or tip of the frame are ⅛″ thick×1½″ wide×shoe size.

The spring tension needed depends on the weight of the wearer.

The molded angle is the spring action of the compressor, so that when the person takes a step the below springs open sucking air through the primary air-filters.

(c). The valve housing 520. The valve housing is made in two sections, the bottom half has a wall all around it and the top part assembles on top of these walls. In a front and cross section view of the valve-housing. (the right side shoe), the top part has the valve seat of the intake-valve facing down and located to the left. The long part or valve guide of the air-pressure-valve facing down and located to the right. This making the bottom half of the valve-housing, with the valve guide of the air-intake-valve facing up on the left and the valve seat of the air-pressure-valve facing up, located to the right.

Right between the valve parts there are three parallel dividing walls 520C. One attached to the top part and two attached to the bottom part of the valve housing 520. The dividing walls serve two purposes; (1) to keep the intake valve side from sucking air from the air pressure side. (2) the wall attached to the top part slides between the two walls attached to the bottom part. This is for easier valve assembly. A rubber gasket goes between the two halves of the valve housing 520.

The valve housing 520 has the shape of a man's shoe heel. At each corner of the shoe heel, there are one ¼″ screw holes and 2½″ across from these two holes there are two more ¼″ screw holes. These screw holes aline with the screw holes of the bellow frame for attachment.

The configuration of the valve-housing from the right shoe to the left shoe is inverted.

The outer and dividing walls; of both halves of the valve-housing are made of ⅛″×⅜″ tall×shoe size of mold injection thermoplastic polycarbonate/acrynolitile butadiene styrene. The top and bottom walls of the valve-housing are made of 3/16″ mold injection P/ABS.

The valve seats for both intake 520 A, and pressure 520B are integrated in the mold injection proses. The measurements for the valve seat wall, is ⅙″ thick×⅛″ high with a ½″ID orifice and a flat 90 deg seat. The valves are 3/16″ thick with a diameter of 11/16″ (with no spring) and are made of P/ABS (this material tends to hold it's shape under pressure).

Because of the low air-suction and air-pressure produced at the priming stage by the bellow air-compressors, a spring type valve cannot be used.

The valve tubes or guides are ⅞″ OD and 3/16″ ID×⅜″ long, with four 3/16″ slots all around the valve guide for air passage.

The intake tube 220 with quick connects 220B and pressure tubes 320 with quick connects 320B have 90 deg. elbows tubes 220A, 320A with loops on the sides for screw attachment to the valve-housing 520. These elbows have rectangular shapes that connect to the valve housing and the inside diameter is 3/16″×1″. This rectangle starts to get conical until is rounded to a ½″ID×4″ long tube. These “tube-elbows” are made of polyamides mold injection thermoplastic.

(e). The shoes 620 are made of nylon fabric or leather. The insole of the shoe is made of breathable synthetic-cotton fabric made of nylon base fibers, and/or Polyester. Soft silicon-based gels for the bottom part of the insole, and for the foot arch foam rubber and manufactured in the same form of a sport-shoe, except for the shoe sole 420. Because the shoe sole assembles on top of the bellow type compressor 20 and plus it looks different from a conventional shoe sole.

The shoe sole 420 is a combination of the ventilation-heating and cooling system of the toes and also has the shape of the bottom of the feet.

The shoe sole 420 is divided into two parts; (1) the upper part which lies on top of the hollow part 420A, and the valve-housing 520. This upper part of the shoe sole is, 3/16″ thick×the size of the shoes. These shoe soles are in the form of the plant of the foot with twenty ⅙″ orifices 720 in the area of the toes. This shoe sole can be made of mold injection styrene-butadiene or other thermoplastics. (2) The other part of the shoe sole is the hollow part 420A that fits in the front of the valve-housing 520 and rests flat on top of the bellow type compressor 20.

The bottom 420A of this second part of the shoe sole is flat and has a wall all around it made of ⅛″×shoe size and of the same material as the first part. The top, or rim part of this wall contours to the shape of the upper part 420 for the assembly of the two parts. These two parts make a hollow space between the two parts.

In the wall of the hollow space, facing the other shoe, is a ¼″ elbow-tube 120A integrated to the wall and located ¼″ from the valve-housing 520. This elbow-tube 120A and hollow space is for the circulation of air from the air-tanks 28. This flow of air, goes down through the copper tubing 116 of the heat-exchanger bag 16 or the vinyl tubing inside the ice-bag or plastic “radiators.” These plastic radiators, are in the form of a cap for the head and flat for the body, one in front and one on the back of the body, for heat-exchange. Then the air goes down through the latex hose 120 to the elbow-tube 120A to the hollow space 420A of the shoe sole 420, then through the small orifices 720 in the shoe sole and shoe innersole and finally to the toes. The quick connect 120B and all other quick connects are made of nylon hard thermoplastic.

The shoes 620 have adjustable shoelaces. These shoelaces are long enough, that goes up the leg of the pants to the waistline. This is so that the person, can adjust the tension of the shoelaces from inside of the suit. The “last two,” shoelace holes are equipped with one-way holding clips with a release lever that has a string attached to it, that also goes up the leg of the pants to the waistline, for the release of the tension of the shoelaces.

The end of the shoelaces and release strings are attached to an elastic material and the elastic to the waistline for leg movement.

(d). The protective boots 19:

The shoe 620, the bellow compressor 20, the suction/pressure tubes and the tube going to the shoe sole are covered by a rigid protective boot 19 made of ⅛″ thick carbon fiber composite (for fire-hazard conditions). This boot is high enough from the bottom of the boot sole to the roof of the boot, to allow the foot to decompress the “bellow” and still have enough clearance between the top of the shoe and the top or roof of the boot.

The carbon composite boots 19 are built in two parts: (1) the lower part of the boot, which is the boot sole plus 1″ of the boot's sidewall. (2) the upper part of the boot which is the rest of the boot including the tube of the boot. These two parts are connected by at least four, ½″ stainless steel latches that are built-in into the carbon fiber composite with an epoxy/resin.

The bottom part of the boot, has a rounded edge at the rim of the wall, that fits into the concave rim of the upper part of the boot. The two parts are sealed with a 3/32″×¼″×boot size polytetrafluoroethylene (TPFE) Teflon gasket.

The tube of the boot gets wider toward the top, for foot-leg movement at the ankle. The tube of the boots is 4″ tall and 6″ in diameter at the top of the connecting ring 18.

The carbon fiber composite boot has a ring that attaches to a slightly bigger ring. The bigger ring is made of carbon fiber composites and is attached to the suit with resins for carbon composite and polyamides-based materials like Aramid, Nomex and other fire and chemical resistant materials.

The boot to suit attachment rings, the boot side attachment ring has a rounded edge at the rim. The suit to boot attachment rings has a ¼″ concave or groove at the rim with a 3/32″×¼″×6″DIA. (Teflon) gasket. These two rings are attached to each another with at least four, ½″ stainless steel fasteners and a protective flap that drop over the fasteners.

The rubber for the boot's sole is made of synthetic rubber ¼″ thick of poly(styrene-butadiene-styrene) for traction and durability or any other polymer rubber.

The side view of the boot sole has a curved shape. This curvature of the sole is to allow the person to take a step with the rigid boots.

The space between the inner sole and the curved boot sole is hollow space 219 and filled with high texturized glass yarn. The rest of the protective boot 19 is lined 119 with HT glass yarn or other insulating material.

For nonhazardous areas, for example for use in summer time, the compressor can be manufactured with sandals instead of the conventional shoes and the protective boots.

The compressor and the components for the sandals are manufactured the same way as for the “shoe-boot-compressors.” However, instead of a complete boot, the upper part of the carbon composite boot has 1″ wide gaps, leaving 1″ straps, which leave an outline of a boot.

The “sandals-air-compressors” can be worn with shorts or any summer outfit. These “sandals-air-compressors” are for the cooling of the head, neck, or any other part of the body that the person might want to cool down. The air-hoses will be exposed at the legs if the person is wearing shorts.

1-B The “backpack air-compressor”29

The specifications of the “backpack air-compressor” are as follows:

(a). The cylinder is 1½″ID×3½″ and the piston is 1 63/64″×1¼″ with a 2½″ stroke. The cylinder-head is ¾″ thick×1¾″OD with four bolt-loops protruding from the cylinder head, for the attachment to the cylinder and to the bottom of the crankcase. The cylinder head, cylinder, piston, rings, pin, connecting-rod, crankshaft and crankcase can be manufactured of carbon fiber composites because of the light weight, heat resistance and self-lubricating properties of this material. Also, these parts can be manufactured of aluminum, iron and mold injection thermoplastics for economic reasons.

The air-compressor 29 situated in the backpack 27, is for the purpose of compressing the already stored air in the low-pressure air-tanks into higher air-pressure.

(b). The air-compressor is attached to the backpack and the “cranking rope” 129 is hooked 229 to the boots 19 as follows:

The compressor 29 is bolted down to a plastic board made out of P/ABS 1″×6½″×12¾ ″, with 1″×1″ hollow cells in the back side of the board and these cells are divided by ¼″ wide walls×¾″ dip, creating fifty hollow cells. The plastic board is bolted down to the backpack frame.

(c). The compressor 29 has two winding pulleys, 5″ in diameter×5/16″ wide one at each end of the piston shaft. These pulleys are spring loaded with a roller-bearing clutch to return the cranking rope 129 back inside into the pulleys.

The cranking rope 3/16″ nylon rope about 30″ long for each leg for a 5′9″ tall person is connected from the air-compressor pulleys to a loop behind of the boot. The rope can be disconnected from the boots when not in use. The “backpack air-compressor” 19 is not essential for the heating and cooling system of the protective suit 10.

The cranking ropes 129 are guided out of the pack by a tube ¼″ ID nylon tube for each rope.

To operate the backpack compressor 29, the wearer has to have the cranking rope 129 connected from the compressor pulleys to the bottom of the boots 229. Once the rope is connected, the person has to bend and extend the legs in order to activate the compressor 29. This can be done while walking, walking in place or laying down on the floor.

The amount of air-pressure and the time it takes to compress, it depends in the velocity, strength and stamina of the person operating the compressor 29.

The backpack and compressor are water tight and will not affect the performances of the compressor if submerged in water. The only parts that are not water tight are the ropes and pulleys.

1-C The “between the legs” bellow type compressor:

The bellow type compressor is design to add air to the air-tanks while the person is lying down and resting on its side. This air-compressor is stored in the backpack and easily attached between the legs and connected with a hose to the air-tanks.

The bellow type compressor is two 12″×12″ plastic boards made of mold injection P/ABS and connected by a neoprene-latex elastomer that stretches to 18″ at knee level. One of the boards has a 2″×2″ air-intake-valve flap with a ½″ exhaust check-valve that connects to the air-tanks. The plastic boards have 2″ nylon straps with velcro material that wraps around the legs for quick attachment. A ½″ clear vinyl air-hose with a quick-connect fitting extends from the backpack to connect the bellow type compressor to the air-tanks. Once the bellow is connected between the legs, the person by spreading the leg's stretches-open the bellow. The bellow fills with air, the intake flap closes and the elastic material of the bellow forces the air out into the air-tanks.

This bellow type compressor can be manufactured of other materials and in the form of an accordion.

### (2) Air-Tanks, Air-Bags, Air-Hoses

The manufacturing of the flexible air-tanks 28 can be of different materials and combinations.

2-A For hazardous areas or extreme conditions:

(a). The inner shell of the tank is made of high-temp., Chemical resistance modified PTFE fluorocarbon. The inner tank is a 5″×22″ with a 0.05″ wall of modified PTFE blown Teflon tanks with mold injection Teflon air-valves. This tank is wrapped by the outer shell.

(b). The outer shell of the air-tank is interwove 3K×3K of carbon fibers and Aramid fiber. At least two air-tanks are used for the protective suit 10 for extreme conditions, for other situations at least one.

The functions are as follows; the low air-pressure tanks are located one in each side of the backpack. These air-tanks are both connected with ½″ vinyl air-hoses to the “under the shoe-air-compressors” in parallel. This way if one tank is punctured the other one can still be inflated by both of the “under the shoe-air-compressors” 20. Check valves' ⅝″ cartridge polypropylene, with nitride o-ring, with stainless steel spring for corrosion resistance, with a 0.05# cracking pressure. These are used to prevent the inflated tank from leaking air into the punctured air-tank.

2-B For nonhazardous areas:

(a). The inner tank can be manufactured of latex or any other elastomer appropriate for this job. The inner tank is 5″ OD×6″ with a ⅙″ wall and the ½″ air-valves are made of mold injected nylon.

(b). The outer shell of the tank is 5″×6″ and made of a 1/16″ knitted wall of any of the following strings, nylon, polyethylene, polyurethane, polyesters etc.

All of the above-mentioned air-tanks can be use for high-air-pressure. Also all of this air-tanks include an air-valve integrated to the main air-tank-valve, for the inflation of the tanks using an air-chuck from an outside source.

2-C The operation of the air-tanks is as follows:

(a). If the person is not familiar with the use of the protective suit 10, instructions are included inside the suit 10, attached to the inner side of the suit's chest.

The suit 10 has a flashlight integrated to a magnifying glass for use inside of the expendable helmet 111/suit 12 just in case the person has to read the instructions, a map, etc. inside of the suit and while semi-isolated from the ambience. This suit expansion 12 can be done by pulling the arms out of the sleeves and assembling a two-piece flexible Carbon composite rod. This rod, arches and is hooked in place at chest level, expending the chest 12 of the suit 10.

The person once is inside the suit 10 and the “side and neck zippers are closed” 21, the wearer will use the APR 24 and tube 123 to suck air directly through a dust and fumes APR filter 23 and exhale through the exhale valve 324 if the air-tanks 28 were not previously inflated.

If the air-tanks 28 of the suit 10 are filled-up with air prior to the use of the suit 10, than the person needs not to suck air through the APR Respirator 24, because pressure from the air-tanks 28 forces the air through the “in-line air-filters” 25.

Just as the person starts to “pump” or activate the “under the shoe air-compressors” 20 the low-pressure air tank start to fill up with air. When the pressure in the low-pressure air-tanks reaches 1 oz of air-pressure, this air-pressure will automatically start to flow through a set of air-filter 25. After the air is filtered, the air will start to flow through a flexible tube 124 the front of the face-guard lens. At this point the wearer can breathe clean air without having to use the lungs to suck for air through the APR respirator 24.

Once the air-pressure inside the suit is slightly above atmospheric pressure a relieve-valve a ½″ neoprene “umbrella” type relieve-valve situated on top of the helmet with a special protective cover will open to relieve some of the air-pressure inside the suit.

If the person has to cross through fire to safety, the “neoprene relieve-valve” and the primary air-filters have shut-off covers with temperature sensitive springs. These safety features are for protection of the person and the equipment. When these covers close, a flap valve opens between the suit and the intake semi-rigid tube, near the shoulder primary filters and the air re circulates inside the suit 10 for breathing and for the cooling system.

The person in this situation has a limited time to get out of the fire. This time is determined by the “concentration”(of which way to go in total darkness created by the smoke) and the agility of the person, and the air-supply in the air-tanks and of course the intensity of the fire.

(b). If the wearer has been trained in the use of the protective suit 10, especially if that person is a first-responder, this person will know and have a list of supplies needed for the best use of the suit 10 in his or her field of expertise.

For example, if this person is a fire-fighter, he or she will make sure to pack a block of dry-ice for the cooling of the suit 10, a 2″×4″×6″ block of ice preferably refrigerated carbon dioxide in the “cool-exchanger” insulated box 22 situated on the side of the suit 10, at the side of the waistline.

Also will have the air-tanks filled up with air ready for consumption, and other supplies pertinent to there job.

A conventional SCBA air-tank can be connected to the protective suit 10 for added recirculation of air.

The use of the protective suit 10 is not limited for use in hazardous areas and can be manufactured of deferent materials other than the ones described. All of this is determined by the job or leisure requirements.

### (3) “Storage of Air, Shock Absorbing, Flotation and Cushioning Air-Bag”

(a). These air-bags and/or balloons are integrated throughout the suit. Each air-bag is part of one set of four air-bags, and are connected in series by integrated tubing but each set is connected to the air-supply tanks in parallel.

The size of each air-bag is 3″×6″ and built-in, into the “water-resistance suit coating made of a latex rubber, or neoprene or a combination of both with built-in check valves and pressure release valves between the air-tank and the integrated tubing connecting all four sets of air-bags, can be used for low air-pressure storage.

(b). The same air-bags described above in section (a) can be used for protection of the person. May protect against, but not limited to, falls less than 6′ high, physical blows with blunt objects and may absorb some of the shock from a bullet impact. Of course the shock absorbing protection against a bullet impact is for protective suits 10 equipped with a bulletproof vest outer shells containing Aramid, and modified Polyethylene fibers or any other material designed for body protection against ballistics.

(c). Also, the air-bags described above may be used for body flotation on water.

The inflation of the air-bags is divided into two categories; (1) the air-bags are inflated alternatively to form three separated sections of air-bags, just in case one bag is punctured in one of the sections, the other two sections will remain inflated. The punctured air-bag can be repaired with liquid latex. (2) The second category is the division of the suit 10 into the upper section to the legs' section. The purpose of this division is to allow the upper part to be inflated first, so that the person can float on water in an “upright” position.

This air bag system can be equipped with an electric sensor trigger to inflate the air-bags. If the wearer flips more then 40 deg. in any direction, a gyroscope electronic switch will activate the 9-v relay pulling the trigger, thus inflating the air-bags. For example falling down a stair case or out of a boat the mercury switches will activate the air-tank trigger thus inflating the air-bags.

(d). Another purpose of these air-bags is for the comfort of the person, if the person had to lie down to rest. For example, if the person using the suit 10 was to rest on a terrain full of sharp rocks. The air-bags will muffle the sharpness of the rocks.

### (4) Materials for the Protective Coverall of the Suit 10

The coverall is made up of several layers of deferent materials.

The material for the outer or first layer is determined by the occupational hazard application of the user.

(a). For fire-hazard environment, the outer or first layer can be made of 8½ oz/sq. yard of highly texturized glass yarn with (optional) aluminized reflecting coating material. Also the first layer can be manufactured of other fire-resistance fabric like Nomex, Aramid, Karmel HTA.

The second layer of material is made of high-temperature nylon plastic 10 mils thick baked into the inner side of the first layer of HT glass yarn, Nomex, Aramid etc. to block any possible air or water transpiration for the protection of the insulation.

The third layer is 0.050″ of highly texturized glass yarn. Other insulation materials can be used in place of the glass yarn.

The fourth layer (optional) is a rubber suit with integrated 3″×6″ air-bags (when inflated), made of 5 mils of latex, and neoprene. The integrated air-bags are on the outer side of the rubber suit.

The fifth and last layer is a removable coverall made of cotton, linen, or any manmade soft fiber fabric with nylon 6.6 as the base product. All of the mentioned layers make the coverall suit less then 8 pounds heavy for a 5′9″ 160# person.

The protective suit 10, with air-bags, made of fire, chemical, and tear-resisting materials is excellent for the protection of the passengers and crew of any aircraft against an aircraft crash and the post crash fire.

The more people on an airplane wearing the protective suit 10, equipped with air-bags (inflated), the less chain reaction of objects and persons crushing the front seating passengers.

Most likely there's going to be a post crash fire, from the fuel engulfing the fuselage after the crash. The survivors wearing the protective suit 10, can try to escape from the burning aircraft, while reducing the heat inside the protective suit 10, with dry ice, or regular ice inside the cooling system insulated cool-exchanger bag 22 of the suit 10. The ice may be obtain from the airplane ice supply.

Again, the survival of the person wearing the suit 10 in a situation like the one just described above, is determined by the mind concentration of what to do once the person is in total darkness caused by the smoke.

(b). For acids, alkaline and biochemical agents, the outer layer can be treated with a coat of 10 mils of acrylonitrile, Butyl, neoprene or other rubbers making the Nomex, Aramid, Karmel HTA or any tear-resisting fabric the second layer. The rubber coating is for protection and quick decontamination-washing of the suit 10.

The second layer is made of 8½ oz/yard of tear-resistance materials like Aramid or Karmel HTA.

The third layer is 0.05″ of HT glass yarn. This material is for the insulation of the suit 10.

The fourth layer is a coating to the third layer of nitrile or other chem-resisting rubbers. This coating of rubber is designed for quick, inside-suit 10 cleaning.

The fifth and last layer is a removable and disposable suit made of a non woven polypropylene material.

(c). For bulletproof, for the head, neck, chest and back area of the body, the first layer is made of Aramid fabric followed by the second layer of high-strength modify fiber of polyethylene fabric and the third and last layer of the head, neck, chest and back is the Aramid layer, which is the continuation of the rest of the suit 10.

The thickness of the bullet proof material will be according to specifications required by the purchaser.

The fourth layer is a rubber suit with integrated 3″×6″ air-bags made of 5 mils of latex and neoprene. This layer is the sixth layer at the head, neck, chest and back section of the coverall 10.

The rest of the suit layers for the bulletproof protective suit 10 is exactly like the fire, bio-chemical-resistant suit 10.

(d). For protection against ultraviolet rays (only two layers), the outer and inner layers for this kind of suit are made out of white cotton, linen, and/or manmade breathable materials, like fabrics specialized for out door use, made out of Nylon 6.6 as the base material.

Between the two layers of cotton or manmade fabrics, runs the vinyl and/or latex tubing for the circulation of air, coming from the “sandal-compressors.”

The person using a suit without the air-bags for cushioning, can inflate an air-mattress with the “sandal-air-compressors,” with an all-purpose air-hose attached to the air-tank.

(e). The zippers 21 for the coverall of the suit 10, for all hazard environments are made of high strength Acetal POM (polyoxymethylene homopolymer) and the tape is made of Aramid fabric. The zipper cover flaps are a continuation of the suit.

For non hazard environment the zipper is made of nylon and the tape is made of polyester fabric.

### (5) In-Line Pressurized Air-Filtration Respirator System

The in-line pressurized air-filter respirator system is designed to aid the person in side the protective suit 10 to breath filtered air with out having to suck the air with the lungs. This is possible by the under the shoe air-compressors 20.

The system is composed as follows: the filter 25 is screwed into a hard polypropylene plastic socket 125 that is connected to a rubber tube 124 that takes the air to the front of the face.

The intake side of the air-filter is connected to a latex rubber socket 225 that is connected to the pressure regulator and air-distribution block 31, by a ⅜″ vinyl air-hose.

The pressure regulator is connected to the flexible air-tanks 28, by a high pressure vinyl air-hose wrapped with nylon threads.

### (6) Gloves with Fingernails, Ventilation-Heating-Cooling System, and Relax-Form of the Hand with Hand Relaxation Pouch

5-A Materials for the different layers of the glove 15 for hazardous areas

(a). For fire-hazard environment, the first layer is made of 0.130″ of knitted highly texturized glass yarn, or Nomex, or Aramid.

The second layer is 5 mils of high-temp nylon or modified fluorocarbon plastic.

The third layer is made of 0.02 HT glass yarn the fourth and last layer is cotton, linen, or synthetic breathable material using nylon 6.6 as a base material.

(b). For acids, alkalines, solvents and biochemical agents, the first layer is made of 10 mils of nitrile.

The second layer is a slice-resistance material like 8½ oz/yard weave of Aramid.

The third and final layer is made of cotton, linen or synthetic material using nylon 6.6 as a base material.

(c). For better gripping purposes the first layer is made of 8 mils of neoprene, or butyl rubber as a base skin.

The second layer is a layer of 10 oz/yard of woven Aramid fabric.

The third and final layer is made of cotton, linen or breathable synthetic material, (d). For non hazard areas and protection against UV rays, the first and second layer are made of cotton, linen and/or breathable synthetic material.

5-B Materials for the gloves' 15 fingernails 115

The fingernails on the fingertips 115, on the palm side of the gloves 15 are essential for grabbing a flat tool from the floor, grabbing small objects like a needle and syringe, reaching for the key of the hazard-materials cabinet, etc. These nails eliminate the desperation of wearing heavy duty gloves when trying to grab small objects.

(a). For fire-hazard environment, acids, alkalines, solvents, biochemical agents, firearm handling, the fingernails are made from a pointed shape to ¼″ wide×1″ long of carbon composite or epoxy, coated with nitrile or other elastomer rubber.

The nails protrude from ⅛″ to ¼″ from the glove's finger tips. The thumbnails have an “L” shape or angle for the purpose of aligning with the other fingernails. This angle is pointing downward when the two hands are flat against each other. Also these angles are to the side where the two thumbs touch each other.

The “trigger” or index finger does not have a fingernail for the purpose of handling power tools and firearms.

(b). For non hazard conditions, the fingernails are made of acrylics, nylon, p/abs or other thermoplastics and the base of the nails are vulcanized, or glued to the tip of the gloves 15.

The gloves' fingernails are designed to aid the person wearing the gloves to picking up small objects and not for prying.

5-C Ventilation heating and cooling for the gloves 15

(a). The ventilation of the gloves is done by air coming from the air-tanks 28 through ⅜″ vinyl tubing up to the glove to suit connecting rings 14. Starting at the connecting rings 14, the tubing 215 changes to latex rubber and is connected with a quick connect 215A. One ⅛″ oval latex tube per finger and these tubes run all the way to the tip of each finger. The tubing runs between the last two inner layers of the glove 15 materials.

(b). The heating of the gloves 15 is done by air coming from the air-tanks 28 through the copper tubing 116 inside the heat-exchanger box 16 situated on the side of the suit's waistline. After passing through the heat-exchanger box, finally goes to the vinyl and latex tubing connected to the gloves 15.

(c). The cooling of the gloves is done by air coming from the air-tanks through the vinyl tubing coil inside the cool-exchange box 22 situated on the side of the suit's 10 waistline. Finally to the tubing 215 connected to the gloves.

5-D The relaxed form of the hand and hand relaxation pouch glove 15

(a). The design of the gloves 15, in the relaxed form of the hand is to eliminate the stress of bending the glove material when working with small objects. Also, this design of the glove aids the fingers for better blood circulation.

(b). The hand relaxation pouch 315 of the glove 15 is to improve blood circulation through the fingers, and eliminate the desperation of wearing gloves all the time while the person is resting during stand-by duty. This extension of the glove 15 allows the person to rub the fingers against each other without detaching the gloves 15 from the suit 10.

The glove to suit connecting ring 14 works and is manufactured the same way as the protective boot 19 connecting ring 18, as described in the compressor material section.

### (7) Human Waste Evacuation System, Water Filtration System, Double Zippered Front Compartment, Vomit Bag

6A The human waste evacuation system FIG. 17

For extreme cold conditions or possible area contamination the person using the suit 10 does not have to get out of the suit to go to the restroom. The suit 10 is equipped with a toilet system FIG. 17 that allows the person to open the suit's behind without letting cold air to flow inside the suit 10. This system is composed of the following.

(a). The urine collection system works in the following manner: in the male, the penis is covered with a latex or vinyl tube like a “condom” connected to a 1″×2″ plastic funnel made of a mold injection thermoplastic styrene-butadiene copolymer that is covered with a 6″×6″ disposable diaper filled with poly(acrylic acid) for absorption of any possible accidental urine spill. The plastic funnel is connected to a ⅜″×14″ vinyl tube to a 6″×12″ polyethylene lined with poly(acrylic acid) plastic urine disposable bag located in a pocket, outside of the suit at thigh level. Also the person can switch bags to a 6″×12″ latex urine collection bag, for recycling of the water in the urine through a set of water filtration system.

(b). The urine collection system in the female works in the following manner: the urethra is covered by a ½″ wide×1″ long×1″ dip, mold injected thermoplastic styrene-butadiene copolymer oval cup-funnel. The cup-funnel is covered by a 6″×6″ diaper filled with poly(acrylic acid) for absorption of any urine spill. The plastic cup-funnel is connected to a ⅜″×14″ vinyl tube to a 6″×12″ polyethylene covered with poly(acrylic acid) urine disposable plastic bag located in a pocket, outside of the suit at thigh level. Also the wearer can switch bags to a 6″×12″ latex urine collection bag, for the recycling of the water in the urine, through a set of water filtration system.

(c). The water in the urine recovery system is the same system used to filter contaminated water. This filtration system is a 3/16″×3″×8″ pneumatic piston and cylinder made of mold injected thermoplastic clear styrene-butadiene copolymer or other thermoplastics.

This syringe is filled up with the urine or contaminated water, then connected to a two stage chemical removing water filter, then through an active carbon bad-taste remover water filter, then through a reverse osmosis water filter and finally to a plastic water collection bottle. All of these is done by the high air-pressure in an air-tank, from the backpack air-compressor 29 pushing the piston in the pneumatic cylinder, against the contaminated water through the water filters.

(d). The outside zippers for all of these systems are 1½″ wide, the outer zipper teeth are made of Acetal (POM) and the tape is made of Aramid fabric. The inner zipper teeth are made of nylon and the tape is made of polyester fabric.

(e). The 12″×12″ plastic bag 32 is made of 10 mils of vinyl plastic with an 8″ plastic zipper in the front bottom of the bag between the legs. This bag is attached to the suit with Nylon zipper teeth and the top edge of the plastic bag is sewed to one of the polyester tapes of the zipper. The other half of the zipper tape is sewed to the suit. One final nylon-polyester zipper closes the inner side of the suit, packing the vinyl plastic bag between the two zippers.

6B The double zipper front compartment 26

The double zipper front compartment 26 is located in the front of the suit at abdomen level. This compartment is to allow plastic sealed food and supplies inside the suit.

If in a contaminated area, this chamber can be used to decontaminate the plastic bags containing the food or the supplies.

This compartment or chamber has two 1″33 12″ zippers, (one for the outside and one for inside of the suit) the teeth are made of Acetal (POM) and the tape is made of Aramid fabric. The inside lining of the compartment can be of a combination of several elastomers, or high temp-resisting nylon plastic.

6C The vomit bag:

The vomit plastic bag is a 12″×12″ polyethylene with a lining of poly(acrylic acid) or other plastics bag with a poly(acrylic acid) lining for liquid absorption, located in the inner front of the suit at chest level. This vomit bag is for the event of the wearer entering the protective suit 10 with some degree of intoxication from a possible contaminated area.

The person has a better chance of getting medical attention, compared to a SCBA or APR respirators that will get clogged if the person vomits or the person will get more contaminated if the breathing apparatus is removed from the face.

### (8) Heater System

The heater system for the protective suit 10 is a heat exchanger that works in the following manner: On the side of the protective suit 10 at the waistline is a 6″×8″ aluminum box insulated with fiber glass 616 wrapped by a small backpack 16 that hangs on the side of the backpack 27.

Inside of the aluminum box there is a copper coil tubing 116 with the two ends sticking out of the pack 16. One of the two ends 116C of the copper coil 116 is connected to the air-supply pressure regulator distribution block 31 with a quick connect 116A. The other of the two ends 116B is connected with the other quick connect 116A to another air distribution block, which is inside the backpack 27 for the heat supply, for the different parts of the suit 10. The end connected to the second distribution block is a ⅜″ insulated copper tubing that goes into the backpack 27 and into the air distribution block. From this air-distribution box the wearer can choose what part of the suit 10 needs heat.

In addition to the copper tubing there is a “gyroscope” like system that has a frame and three rings. The biggest of the three rings 416 is attached to the frame 516 by two pins in an vertical manner. The medium size ring, is attached with two pins to the large ring in an horizontal manner, and this same medium size ring, is attached by two additional pins to the sides of a smaller ring, also in a horizontal way.

A 4 oz can of 3.3% methyl alcohol cooking fuel 316 or candle 316 hangs in the middle of the small ring. The alcohol or the candle are ignited by a butane candle lighter.

The inside of the aluminum box is aerated for the combustion of the alcohol or candle by a steady flow of air coming from the air tanks. This air flow goes through a ⅜″ copper tube 216B spliced and connected by a quick connect 216D and into the lower part of the aluminum box. The quick connect 216D has a check valve to stop any possible back draft into the air-tanks.

The aluminum box has a ⅜″ exhaust tube 216A spliced out side the pack 16 by a quick connect 216C that goes out of the top of the backpack. At the end of the exhaust tube is a flexible plastic hose that lies across the top of the backpack 27 with a float at the end, that serves as a valve if the wearer happens to jump into dip water. The heating system is water tight for operation if submerge in water.

### (9) Chair of the Protective Suit

The integrated toilet system of the suit 10 has a “chair” integrated to the suit FIG. 17.

(a). The double ⅛″×3″×8″(plastic or carbon fiber composite) shin protectors 17 separate from the bottom part of the shin, by hinges attached to the knee of the suit 10 to extend as chair legs 117.

Two ⅜″×1″×7″ carbon composite sliding braces 217 attach the bottom of the open-position shin protector, to the other half of the shin protector attached to the leg. When the two shin protectors are extended and lock in place the person is ready to kneel over the shin protectors and these help as chair legs.

(b). The other two ⅛″×¾″×12″ carbon composites tube legs 130 for the chair, extend from the backside of the wearer's upper leg section 30 and attach to the boots 19 with straps 230. When the person stands-up, the side legs just slips off the boots' straps. All four chair legs adjust in length to the persons comfort needs.

### (10) Expandable Helmet and Hood

The front of the suit 12, and helmet extend 111 for comfort of the person

(a). The helmet 11 shell is made in two sections and these two sections are joined by an integrated carbon composite hinge 111 on the front top (2″ from the “forehead” of the helmet). In addition it has two ½×4″ carbon fiber composite braces to hold apart the front part of the helmet from the back part of the helmet. The helmet 11 hard shell is made of ⅛″×(the size of the persons head), carbon fiber composites.

The inner cushioning system is ¾″×¾″×¾″ (¾″ apart from one another) plastic cubes filled with silicon-based gel covered with breathable synthetic like cotton fabric. These plastic cubes are part of the lining of the helmet that contains the tubing mash for the ventilation-heating-cooling system of the head.

The helmet 11 is attached to the hood and face-shield or goggles with four carbon fiber composite frames, two for the face-shield 311 or goggles 211 one for the end of the hood opening and one for the helmet.

For insulation purposes, the helmet or hood have two face-shield, or goggle lenses with a frame in between the lenses, in order to form a vacuum space.

All four frames assemble together with six ½″ stainless steel latches with nitrile gaskets among the four frames. The front part of the helmet has the frame that attaches to the face-shield or goggles and hood of the protective suit 10.

The helmet 11 can be made of thermoplastics like polyesters base, hard plastics.

The hood of the suit is oversize for the expansion of the helmet to keep it watertight and a 1″ wide elastic is sewed to the back of the hood to keep the excess fabric in place.

(b). For protective suits 10 not requiring a hard hat, the hood has inflatable ¾″×¾″×14″ latex rubber air-bags from the front to the back of the hood. This system requires three carbon composite frames two for the face-shield or goggles for insulation purposes, and one for the end of the opening of the hood. These three frames assemble together with six, ½″ stainless steel latches.

### (11) Face Shield and Eye Protective Goggles

(a). The face-shield 311 or goggle lenses 211 for fire and chemical hazard environments, are made of 3/32″ of thermoset polycarbonates with carbon-carbon chains for shatter proof and high temp-resistance. These lenses are made to the shape of the carbon fiber composites frames of the face-shield or goggles.

Each set of lenses is divided by one carbon composite frame, forming a ½″ gap. This gap between the two lenses is a total vacuum space. This vacuum space is for the purpose of insulating the inside of the protective suit 10, and the double lens serves as a superior protection against small caliber weapons.

(b). The face-shield or goggle lenses for non hazard conditions can be made of clear or tinted mold injection thermoplastics like polyethylene terepthalate (PET) or polycarbonate of bisphenol A. The frames can be made of thermoplastics with polyamides like nylon 6 or nylon 6,6 or other thermoplastics.

### (12) Audio System

The protective suit 10, needs a 9-v dc battery-operated, intercom system, to hear and speak with people. Once the person is inside the protective suit 10 audio is limited, so an electric audio device is needed.

This audio system can work by wire or FM waves, connect to the outside microphone and speaker. This system eliminates the need of opening the suit to communicate.

Two microphones are needed, one located in the inside front part of the helmet and one outside of the suit to hear the surroundings.

Three speakers, one for the outside of the suit and one for each ear, integrated to the inside of the helmet.

Other audio and visual equipment can be installed on the suit 10 for safety purposes.

### (13) Air-Bag Suit with Parachute

The air-bag-suit with parachute is design for free falls, from a burning building. The air-bag-suit with parachute can be integrated to the protective suit 10, and works in conjunction with the air-compressors 20 or 29 system of the suit 10.

I have two kinds of air-bag suit with parachute systems and work in the following manner:

(a). System #1 (describing the air-bags only). The person gets inside of the protective suit 10, and will proceed to get inside the air-bag-suit with parachute and close the suit's entrance with the plastic loop and hook (Velcro) latching straps.

The air-bag-suit with parachute has at least ten air-bags that inflate to 3′ (three feet) all around the wearer. These air-bags are made of high temperature resisting nylon plastic, covered with a net of fire resistant material like Aramid or Nomex or other fire resistant materials.

If trapped by fire, the wearer must hang from a window frame or stand on a balcony or on top of the roof of the burning building before inflating the big air-bags. A fifty-foot fire-resistant supporting strap with a hook and with a quick release system is furnished with the air-bag with parachute suit just in case the wearer can lower his or her self to safety.

The wearer inflates the air-bags in the “air-bag-suit with parachute” with a 20 Oz Co2 tank or a 68 ci 4500 psi carbon fiber wrapped nitrogen tank. After manually pulling the trigger to fill up the air-bags, the wearer is ready to jump off the building, that's only if the circumstances force the person to jump off from a tall building.

(b). System #2 (describing the air-bags only). System #2 is a more sophisticated piece of equipment that uses different technologies. This suit also has at least ten air bags as described for system #1, for the different sections and contours of the body. These air-bags also inflate to 36″ and have a fire resistant net that holds the shape of the air-bags.

These air-bags are individually packed in their corresponding compartments in the “air-bag-suit with parachute”.

All of the air-bags are simultaneously inflated by a discharge from a 68 ci 4500 psi carbon fiber wrapped nitrogen tank, with a two-stage pressure regulator for the inflating trigger system.

The two-stage pressure trigger system is activated by a set of six laser distance-measuring sensors, all pointing to different angles, which sends continues measurement signals to a microprocessor. Which in turn activates the electronic board to activate a 9-v dc relay that pulls the trigger for the controlled release of the nitrogen.

When the distance measuring sensors send any combination of measurements which show a sudden change of room or space dimensions, these signals will activate the trigger system and the air-bags will inflate. (This same system forces open the parachute).

I recommend that people working in tall buildings practice jumping into an air-bag supervised by professionals in this field. Or at least get acquainted with the instructions for use of this equipment.

Dimensions and materials for the “air-bag-suit with parachute” are as follows: is a big double suit, made of 8 oz/sq/yard of Aramid fabric. The inner suit is made to the size of the wearer. The outer suit is big enough to inflate ten 24″×24″×36″ of 20 mils of high-temperature-resisting nylon plastic air-bags between the two suits and all around the person.

These air-bags can be in flatted with air from the protective suit 10 air-compressor systems, or from a nitrogen, helium, or Co2 cartridges or tanks.

The air-bags are equipped with 1″ plastic relief valves, these are spring loaded check-valves to minimize bouncing once the body lands against the air-bags.

Elastic material keeps the deflated suit together for easier handling.

The inflation system with Co2 gas cartridges, nitrogen gas or helium gas is the same as the Co2 factory made tire inflating system.

The parachute system is composed of a ⅜″ thick×36″ wide×52″ tall carbon composite frame 33 attached permanently to the air-bag-suit with a 6″ gap between the suit and the frame. This frame 33 has a permanently attached Aramid fiber net to hold the parachute in place and also to let air flow through the net for the parachute's expansion.

The materials for the parachute of the protective suit 10, are made of the lightweight polyamide-based fibers and other fire-resistant fibers.

(c). System #1 (describing the parachute). In the system #1 of the “air-bag suit with parachute”, the parachute is released by pulling a cord connected to a trigger, which is connected to a Nitrogen or Co2 gas tank which are used to blow open the parachute through the Aramid fiber net on the carbon composite frame. This burst of gas will open the parachute's protective flaps and extend the parachute quicker than a conventional parachute.

The strings are Aramid fibers and long enough for the parachute's canopy to be only 102″ from the wearer. The parachute opens to at least a 90″ diameter size canopy. A dome of 40″ tall forms at the center of the canopy, measuring from a horizontal imaginary line where the canopy is attached to the strings. All of these measurements increase according to body weight. The center of the canopy has a 4″ hole for the directional stability of the parachute.

The reason for the big frame is to help the parachute to open quicker if the wearer panics and does not pull the cord. Also, to force the wearer to fall face down in case the person falls backwards. The more body weight distribution landing against the air-bags, the less possibility of injury from falls less then 50 ft.

The parachute may not open completely in falls less then 50 ft., in this case the wearer can extend the parachute before jumping off the burning building. If the parachute is open be fore jumping off the building a skirt 133 all around the parachute's canopy will inflate with Helium gas and maintain the parachute open above the wearer. This skirt or balloon may help steer the parachute by pulling the extra strings 233 connected to the skirt 133 by pulling ether side of the skirt closer to the parachute's canopy. Eight strings 233 are connected evenly all around to the skirt 133.

If the parachute fails for any reason the wearer has to rely on the sole big air-bags protection of the “air-bag suit with parachute”.

In case the wearer panics and does not pull the cord, the parachute unfolds automatically by the force of the air resistance created against a smaller parachute that pulls the trigger of the nitrogen tank blowing the protective flaps covering the canopy material by the acceleration of the falling person.

The parachute frame is designed to force a conscious or unconscious falling person to drop in a face down position. The higher the fall the more time the parachute's frame has to help the falling person to shift to a face down position. The helmet and air-bags absorb the landing shock of the fallen body.

The falling of a human body in a horizontal position, is critical to help break some of the acceleration created by the electrical substance found in the earth's atmosphere. Which I believe forces all matter to balance in the center of our atmosphere. I, will like to comment that I have figure-out in my mind that the center of the earth does not have pulling powers or gravity. It is all controlled by electrical substances (electricity in the atmosphere) that create impulses if some thing is out of place in the universe! I have heard about two clever explanations about gravitational forces, and I specially disagree with the oldest one.

This brief explanation of what I have observed in the elements, help me understand the reaction several materials will have flying down against the invisible elements.

(d). System #2 (explaining the parachute). System #2 of the “air-bags with parachute” is the same as system #1 but with the exception that this system works in conjunction with the laser system that inflates automatically the air-bags of the “air-bag suit with parachute” in system #2.

When the distance measuring laser sensors situated in different parts of the suit, indicate two or more sudden distance changes, specially from the floor and walls, the microprocessor will send a signal to the electronic board to activate the trigger solenoid. When the trigger is pulled for the controlled discharge of nitrogen gas, the nitrogen gas goes through the net holding the parachute, thus extending the canopy.

A gyroscope system will indicate the microprocessor if the falling body is upright, or backwards. If the body is falling back wards the big frame will help the body to turn so that the microprocessor can send the signal so that the parachute will open.

The on-off switch of the laser system is activated by body motion of the wearer. This kind of automatic electronic switch is for the purpose of aiding the wearer in time of distress and saving the batteries. This system has an alarm for low battery and low nitrogen pressure.

All of the described features of the suit 10 can be manufactured according to each individual trade or profession to serve, and look accordingly. For example, an executive person can wear the protective suit 10 in the shape of a two piece business suit. Another example, will be an airplane passenger can wear a protective suit 10 looking like a set of casual garments. In this two examples the suit 10 will have inflatable hoods for head protection instead of a helmet.

The total weight of the protective suit 10, plus the most essential supplies is forty pounds for an average size adult man. The total weight of the protective suit 10 will differ according to the length and thickness of the measurements, and materials used for the manufacturing of the same.

1. I claim: to have invented a self-contained protective suit that produces, carries, and utilizes the energy generated by the body weight against the floor, and other movements of the body propelling any air-compressor, or power generating device, attached as part of the protective suit, for mass protection and mass continuation.

2. I claim: to have invented a portable air-compressor system that is attached and operates beneath the shoes and protected by boots in hazardous conditions.

3. I claim: to have invented the pressurized respirator air-filtration system, functional by the portable air-compressors beneath the shoes, that will help the person to breathe filtered air without having to suck the air through the filters with the lungs.

4. I claim: to have invented a fire-fighter's protective suit with integrated helmet, that re-circulates the air inside the suit, while semi-isolated, or isolated from the surroundings, functional by the integrated, beneath the shoes air-compressors, and protected by fire resistant boots.

5. I claim: to have invented the expandable helmet and expandable protective suit for purposes of allowing the user to relax, read guiding instruments, eat, sleep, and other activities inside the protective suit while isolated or semi-isolated from the environment.

6. I claim: to have invented the helmet with vacuum in between the double lenses, with ventilation, heating, and cooling system to the head, face, and neck, connected and functional by the air-compressor system integrated beneath the shoes.

7. I claim: to have invented the inflatable protective suit for water flotation, shock-absorbing, and air-storage, functional by the portable air compressors located beneath the shoes.

8. I claim: to have invented the gloves with fingernails, ventilation-heating and cooling system, and relax form of the hand with a hand relaxation pouch, functional by the air-compressor system integrated beneath the shoes.

9. I claim: to have invented the adjustable abdominal belt and back support, both including air-bags; for lifting, walking, standing, seating, and laying down, functional by the air-compressor system integrated beneath the shoes.

10. I claim: to have invented a toilet system with folding legs, integrated to a protective suit, with a water purifying system, functional by the air-pressure from the compressors integrated beneath the shoes and in the integrated backpack of the protective suit.

11. I claim: to have invented an air-bag rescue suit with parachute, inflatable manually, or by a 9-v dc automatic laser electronic-mechanical device, with any of the following gases: nitrogen, helium, carbon dioxide, or air supplied by the air-compressors integrated into the protective suit, necessary for emergency or forced jumps from burning buildings.
